(19) United States
(12) Patent Application Publication
(10) Pub. No.: US 2015/0049252 A1
(43) Pub. Date: Feb. 19, 2015

(54) DISPLAY DEVICE, CONTACTLESS POWER SUPPLY SYSTEM EQUIPPED WITH DISPLAY DEVICE, AND TELEVISION RECEIVER EQUIPPED WITH DISPLAY DEVICE

(71) Applicants: Kohichiroh Matsuhisa, Osaka-shi (JP); Kohji Nakagawa, Osaka-shi (JP); Yasuhiro Nobutoki, Osaka-shi (JP); Nobuyuki Hashimoto, Osaka-shi (JP); Yoshitaka Matsui, Osaka-shi (JP)

(72) Inventors: Kohichiroh Matsuhisa, Osaka-shi (JP); Kohji Nakagawa, Osaka-shi (JP); Yasuhiro Nobutoki, Osaka-shi (JP); Nobuyuki Hashimoto, Osaka-shi (JP); Yoshitaka Matsui, Osaka-shi (JP)

(73) Assignee: SHARP KABUSHIKI KAISHA, Osaka-shi (JP)

(21) Appl. No.: 14/388,112

(22) PCT Filed: Sep. 14, 2012
(86) PCT No.: PCT/JP2012/073725

§ 371 Date: Sep. 25, 2014

(30) Foreign Application Priority Data
Mar. 27, 2012 (JP) 2012-072200
Aug. 24, 2012 (JP) 2012-185858

(51) Int. Cl. H04N 5/63; H02J 5/00; H02J 7/02; H01F 38/14

(52) U.S. Cl. CPC H04N 5/63; H01F 38/14; H02J 5/005; H02J 7/025
USPC 348/730; 307/104

(57) ABSTRACT

A television receiver (3) is a portable display device having a handle (not illustrated) in which a power receiving coil (8) for contactless power supply is embedded.

### TECHNICAL FIELD

The present invention relates to a portable display device, a contactless power supply system for charging this display device, and a television receiver including the display device.

### BACKGROUND ART

In recent years, reduction in weight of a television receiver has led to an increasing demand for a portable television receiver (hereinafter, referred to as a portable television) that can be carried around more easily and that allows easier attachment/detachment of the television receiver to/from a wall. As such a portable television, there is a model that has been developed. In this model, a built-in buttery is provided, so that a power cord of the model does not become cumbersome at the time when the model is carried around. Accordingly, the model can be carried around more easily.

Conventionally, a power cord has been used for charging an electronic device having a built-in battery. However, currently, a contactless power supply system for supplying power without use of a power cord is attracting attention. For example, Patent Literature 1 discloses a contactless power supply system that carries out contactless power supply to a portable television having a power receiving section from a power supplying section attached to a floor, a wall, or the like, by attaching the portable television to the power supplying section. This makes it possible to supply power to a portable television including a power receiving section, only by attaching the portable television to a power supplying section. Further, wiring by use of a power cord become unnecessary. This makes it possible to prevent a mess of wires.

As one of such a contactless power supply method, there is an electromagnetic induction type. According to the electromagnetic induction type, first, a high-frequency alternating-current power is applied to a power transmitting coil of a power supplying section so that a high-frequency magnetic field is generated. Then, a power receiving coil of a power receiving section is magnetically connected to the power transmitting coil. Thereby, an alternating-current power is induced by electromagnetic induction in the power receiving coil. Accordingly, the power receiving section can receive power from the power supplying section in a contactless manner.

### CITATION LIST

### Patent Literature

### Patent Literature 1

Japanese Patent Application Publication, Tokukai, No. 2011-147513 (Publication Date: Aug. 4, 2011)

### SUMMARY OF INVENTION

### Technical Problem

According to the above-described electromagnetic induction type, it is necessary to ensure a space for provision of a power receiving coil inside a portable television. Here, because a thickness of the portable television has been reduced in recent years, it has particularly become an important problem to ensure a space for provision of a power receiving coil in a thin portable television.

Further, a thin portable television increases the possibility that a power receiving coil is provided adjacent to a metal member inside the portable television. In this case, the metal member may resonate and generate heat due to influence of the power receiving coil. Therefore, it is desirable to provide the power receiving coil in a position that does not cause heat generation of the metal member that occurs due to influence of the power receiving coil.

The present invention is attained in view of the above problem. An object of the present invention is to provide a portable display device in which a space for provision of a power receiving coil can be sufficiently ensured and in which a metal member does not generate heat due to influence of the power receiving coil, a contactless power supply system including the display device, and a television receiver including the display device.

### Solution to Problem

In order to solve the above problem, a display device of the present invention is a portable display device having a handle in which a power receiving coil for contactless power supply is embedded.

In the above arrangement, the power receiving coil is embedded in the handle of the display device. In this way, the power receiving coil is embedded in the handle of the display device and thereby, a space in the handle is effectively utilized. Accordingly, it becomes unnecessary to separately provide a space for provision of the power receiving coil, in a space inside the display device. This makes it possible to embed the power receiving coil even in a thin display device without any problem.

Further, by having an arrangement in which only a structure of the handle can be designed as appropriate, it becomes possible to design a handle independently from a size and a shape of a main body of the display device so that the handle has a desired structure. In other words, even in a case where a power receiving coil in accordance with a required transmission power is to be embedded, the handle can be designed in accordance with the power receiving coil to be embedded.

Further, because the power receiving coil is provided in the handle of the display device, it is possible to provide a distance between the power receiving coil and a metal member such as a backlight chassis inside the main body of the display device. This makes it possible to minimize heat generation of the metal member which occurs due to the power receiving coil.

In order to solve the above problem, a contactless power supply system of the present invention includes: any one of the above-described portable display devices; and a power supply device including a power source section to which external power is supplied, and a power transmitting coil for contactless power supply, the power transmitting coil being supplied with power from the power source section, in a case where the handle is in a predetermined position in proximity to the power supply device, the contactless power supply being carried out so that the power is supplied to the portable display device by magnetic connection between the power transmitting coil and the power receiving coil.

In the above arrangement, by utilizing electromagnetic induction between the power transmitting coil and the power receiving coil, it is possible to carry out contactless power supply to the display device. Particularly, because the power receiving coil is embedded in the handle of the display device, it is not necessary to separately provide an additional member for the contactless power supply. This makes it possible to carry out contactless power supply to a thin display device without any problem.

Further, in order to solve the above problem, a television receiver of the present invention includes the above-described portable display device.

The above arrangement makes it possible to provide a portable television receiver in which a space for provision of the power receiving coil can be sufficiently ensured and in which heat generation of a metal member due to influence of the power receiving coil does not occur. For a fuller understanding of the nature and advantages of the invention, reference should be made to the ensuing detailed description taken in conjunction with the accompanying drawings.

### Advantageous Effects of Invention

In the present invention, the power receiving coil is embedded in the handle of the display device and thereby, a space in the handle is effectively utilized. Accordingly, it becomes unnecessary to separately provide a space for provision of the power receiving coil, in a space inside the display device. This makes it possible to embed the power receiving coil even in a thin display device without any problem.

Further, because the handle where the power receiving coil is embedded is not entirely in contact with the main body of the display device, it is possible to provide a distance between the power receiving coil and a metal member such as a backlight chassis inside the main body of the display device. This makes it possible to minimize heat generation of the metal member which occurs due to the power receiving coil.

### BRIEF DESCRIPTION OF DRAWINGS

FIG. 1 is a block diagram illustrating an overall arrangement of a contactless power supply system according to one embodiment of the present invention.

FIG. 2 is a view illustrating one example application of a contactless power supply method in which example application an electromagnetic induction type is employed.

FIG. 3 is a view illustrating a state where power is induced in a power receiving coil as a result of magnetic connection between a power transmitting coil and the power receiving coil.

(a) of FIG. 4 is a view illustrating a state where the contactless power supply system according to one embodiment of the present invention is not supplying power, while (b) of FIG. 4 is a view illustrating a state where the contactless power supply system according to one embodiment of the present invention is supplying power.

FIG. 5 is a perspective view illustrating an angle according to one embodiment of the present invention.

FIG. 6 is a view illustrating a back surface and a side surface of a portable television according to one embodiment of the present invention.

FIG. 7 is a view illustrating one example arrangement of a portable television according to one embodiment of the present invention.

FIG. 8 is a view illustrating a positional relation between a handle and a metal member such as a backlight chassis inside a main body of a portable television according to the present invention. (a) of FIG. 8 illustrates a case where the handle is provided in the center of a back surface of the portable television, while (b) of FIG. 8 illustrates a case where the handle is provided in a position where a portion of the handle extends beyond a top edge of the portable television.

FIG. 9 is a view illustrating a back surface of a portable television according to one embodiment of the present invention having a power receiving coil that has a rectangular loop shape.

FIG. 10 is a side view illustrating an angle according to one embodiment of the present invention.

FIG. 11 is a view illustrating an internal arrangement of an angle according to one embodiment of the present invention. (a) of FIG. 11 illustrates a state in which a portable television according to one embodiment of the present invention is not hung on the angle, while (b) of FIG. 11 illustrates a state in which a portable television according to one embodiment of the present invention is hung on the angle.

(a) and (b) of FIG. 12 are views each illustrating a state in which a portable television according to one embodiment of the present invention is not hung on an angle.

(a) and (b) of FIG. 13 are views each illustrating a state in which a portable television according to one embodiment of the present invention is hung on an angle.

FIG. 14 is a flow chart showing a method of supplying power by a contactless power supply system according to one embodiment of the present invention.

(a) of FIG. 15 is a view illustrating a state in which a portable television according to one embodiment of the present invention is not hung on an angle, while (b) of FIG. 15 is a view illustrating a state of a power transmitting coil and a power receiving coil at the time when a portable television according to one embodiment of the present invention is not hung on the angle.

(a) of FIG. 16 is a view illustrating a state in which a portable television according to one embodiment of the present invention is hung on an angle, while (b) of FIG. 16 is a view illustrating a state of a power transmitting coil and a power receiving coil at the time when a portable television according to one embodiment of the present invention is hung on the angle.

FIG. 17 is a flow chart showing a method of supplying power by a contactless power supply system according to one embodiment of the present invention.

### DESCRIPTION OF EMBODIMENTS

The following embodiment discusses the present invention in detail. Note that in the following description, members having an identical function and identical effects are given an identical reference sign and a repeated explanation of the members is omitted.

(Contactless Power Supply Method of Electromagnetic Induction Type)

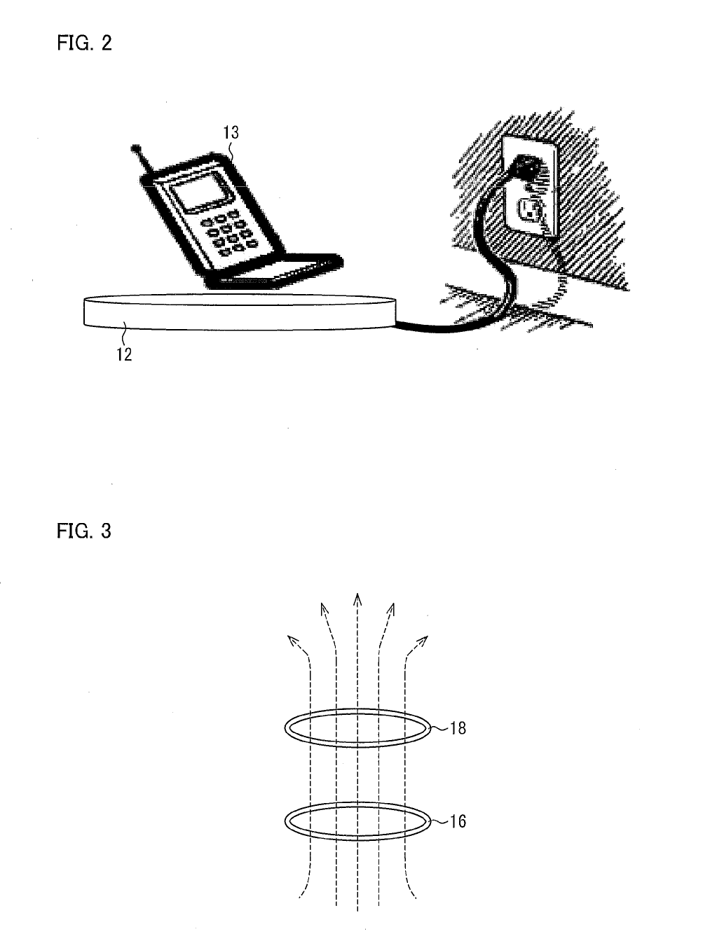

Prior to discussion on a contactless power supply system according to one embodiment of the present invention, the following briefly describes a power supply method employed in the contactless power supply system according to one embodiment of the present invention. In the contactless power supply system according to one embodiment of the present invention, a contactless power supply method of an electromagnetic induction type is employed. FIG. 2 illustrates one example application of the contactless power supply method of the electromagnetic induction type.

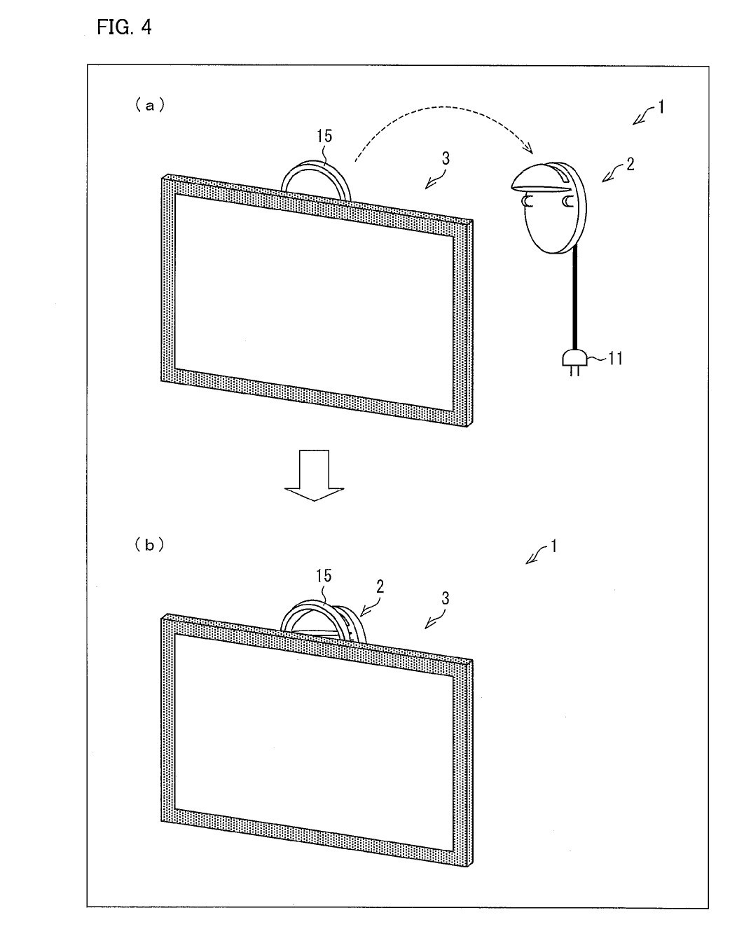

As illustrated in FIG. 2, a mobile phone 13 is a subject of power supply. In a state where the mobile phone 13 is mounted on a power supply device 12, power is supplied from the power supply device 12 to the mobile phone 13. More specifically, the power supply device 12 includes a power transmitting coil 16 as illustrated in FIG. 3, while the mobile phone 13 includes a power receiving coil 18 as illustrated in FIG. 3. In contactless power supply carried out by the electromagnetic induction type, a high-frequency alternating-current power is applied to the power transmitting coil 16 so that a high-frequency magnetic field is generated. Then, the power receiving coil 18 is magnetically connected to the power transmitting coil 16 so that an alternating-current power is induced by magnetic induction in the power receiving coil 18 (dotted line in FIG. 3). As a result, the mobile phone 13 can receive power in a contactless manner from the power supply device 12. The contactless power supply system according to one embodiment of the present invention utilizes this contactless power supply method of the electromagnetic induction type.

(Contactless Power Supply System 1)

The following discusses in detail the contactless power supply system according to one embodiment of the present invention. In the contactless power supply system according to one embodiment of the present invention, power is supplied by means of contactless power supply to a portable display device including a handle, from a power supply device. The following discusses a contactless power supply system 1 according to one embodiment of the present invention, by taking, as an example, a case where the display device is a television receiver and the power supply device is an angle for hanging the television receiver on a wall. Note that the television receiver and the angle are only one example, and the contactless power supply system 1 according to one embodiment of the present invention is not limited to this arrangement. For example, as the display device, a display of a personal computer or the like is also applicable, while as the power supply device, a device designed only for supplying power to a display device, a rack on which the display device is to be mounted, or the like is also applicable.

FIG. 4 schematically illustrates the contactless power supply system 1. (a) of FIG. 4 illustrates a state where the contactless power supply system 1 is not supplying power, while (b) of FIG. 4 illustrates a state where the contactless power supply system 1 is supplying power. As illustrated in (a) of FIG. 4, the contactless power supply system 1 includes a portable television receiver 3 (hereinafter, referred to as a portable television) and an angle 2 attached to a wall. To the portable television 3, a handle 15 is provided. By attaching the handle 15 to the angle 2 as illustrated in (b) of FIG. 4, the portable television 3 can be hung on the angle 2 (wall). In the contactless power supply system 1, power is supplied to the portable television 3 by the angle 2. The power is supplied to the portable television 3 depending on whether or not the portable television 3 is in a predetermined position in proximity to the angle 2. The above predetermined position is not specifically limited, as long as the predetermined position is a position that allows the angle 2 to carry out contactless power supply to the portable television 3. In other words, the predetermined position only needs to be a position that allows the power transmitting coil and the power receiving coil which are discussed later to be magnetically connected to each other.

The following description is provided on the assumption that a state where the portable television 3 is hung on the angle 2 means that the portable television 3 is in the above predetermined position. Accordingly, in a state where the portable television 3 is not attached to the angle 2 as illustrated in (a) of FIG. 4, power is not supplied from the angle 2 to the portable television 3. Meanwhile, in a state where the portable television 3 is attached to the angle 2 as illustrated in (b) of FIG. 4, power is supplied from the angle 2 to the portable television 3. In this way, the angle 2 supplies power to the portable television 3, depending on whether or not the portable television 3 is hung on the angle 2.

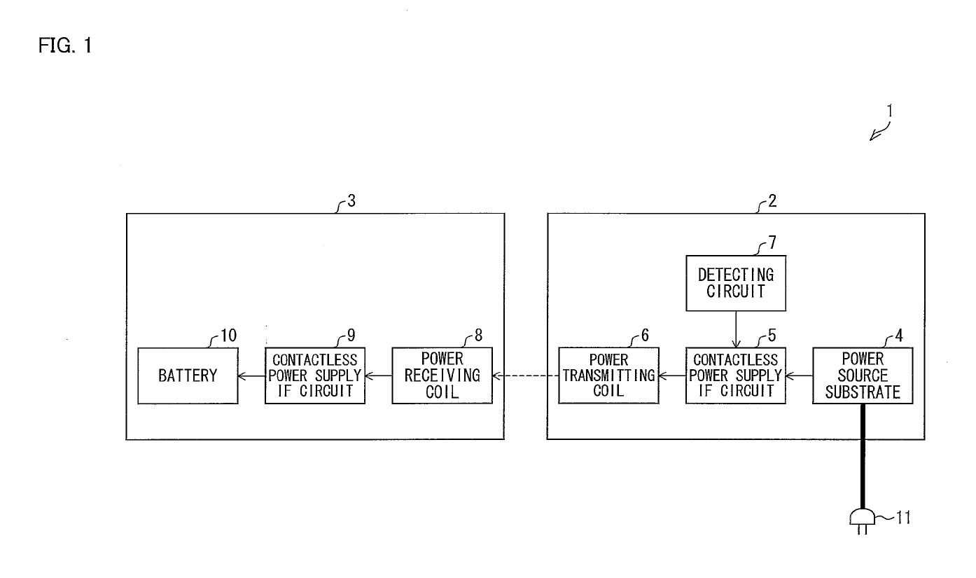

FIG. 1 is a block diagram illustrating an overall arrangement of the contactless power supply system 1 according to one embodiment of the present invention. As illustrated in FIG. 1, the angle 2 includes a power source substrate 4 (power source section), a contactless power supply IF circuit 5 (power source section), a power transmitting coil 6, a detecting circuit 7 (detecting section), and a plug 11. Meanwhile, the portable television 3 includes a power receiving coil 8, a contactless power supply IF circuit 9, and a battery 10. Note that though the portable television 3 includes various members for causing the portable television 3 to function as a television receiver, for simplification of this drawing, FIG. 1 illustrates only members that are relevant to contactless power supply. The following discusses the angle 2 and the portable television 3 in order.

(Angle 2)

As illustrated in FIG. 1, the angle 2 includes the power source substrate 4, the contactless power supply IF circuit 5, the power transmitting coil 6 for contactless power supply, the detecting circuit 7, and the plug 11. The plug 11 of the angle 2 is connected to an external power source such as a socket outlet, and thereby obtains power from the external power source. The power source substrate 4 is a substrate connected to the plug 11. The power source substrate 4 supplies, to the contactless power supply IF circuit 5, a direct-current power converted from an alternating-current power which the plug 11 has obtained from the external power source. The contactless power supply IF circuit 5 further converts the direct-current power to a high-frequency alternating power, and supplies thus converted high-frequency alternating voltage to the power transmitting coil 6. When the high-frequency alternating voltage is supplied to the power transmitting coil 6, a magnetic field is provided, so that the power transmitting coil 6 and the power receiving coil 8 are magnetically connected to each other.

The detecting circuit 7 of the angle 2 is a circuit for detecting whether or not the portable television 3 is in a predetermined position in proximity to the angle 2. Accordingly, the detecting circuit 7 detects whether or not the portable television 3 is hung on the angle 2. More specific detection methods will be discussed later, but the detecting circuit 7 detects whether or not the portable television 3 is hung on the angle 2 and sends information on a result of this detection to the contactless power supply IF circuit 5. In accordance with the information sent from the detecting circuit 7, the contactless power supply IF circuit 5 supplies power to the power transmitting coil 6 when the portable television 3 is hung on the angle 2. However, the contactless power supply IF circuit 5 does not supply power to the transmitting coil 6 when the portable television 3 is not hung on the angle 2. In this way, the angle 2 supplies power to the portable television 3 in accordance with the result of the detection by the detecting circuit 7.

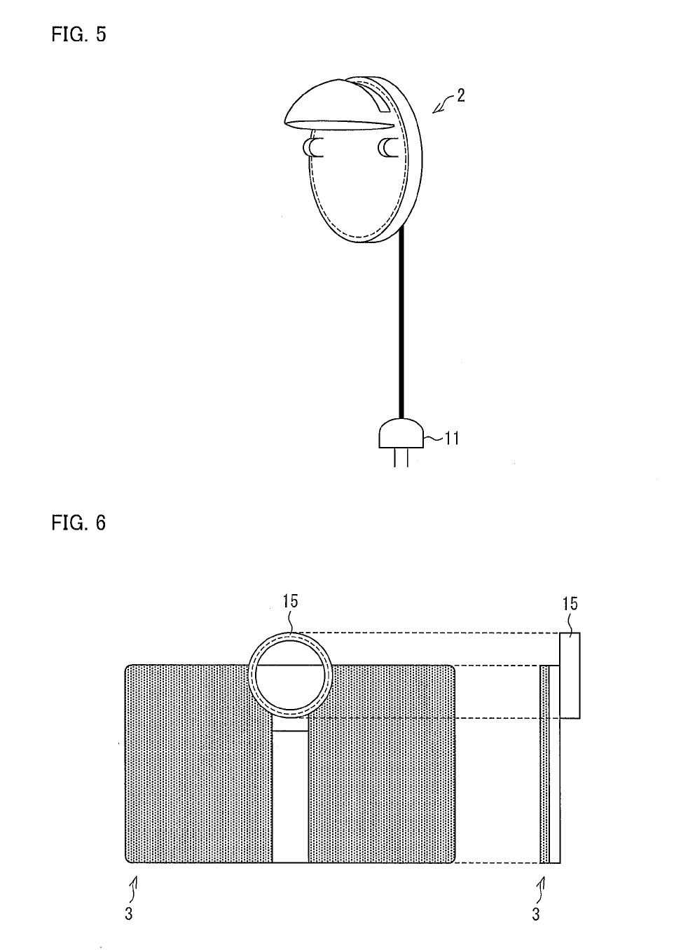

FIG. 5 is a perspective view of the angle 2. As illustrated in FIG. 5, the angle 2 has a structure for hanging the handle 15 of the portable television 3. Inside the angle 2, the power transmitting coil 6 having a ring shape is embedded. More specifically, as indicated by a dotted line in FIG. 5, the power transmitting coil 6 is embedded along an outer rim of the angle 2.

(Portable Television 3)

As illustrated in FIG. 1, the portable television 3 includes the power receiving coil 8 for contactless power supply, the contactless power supply IF circuit 9, and the battery 10. As a result of supply of the alternating-current power to the power transmitting coil 6, the power transmitting coil 6 and the power receiving coil 8 are magnetically connected to each other. Then, an alternating-current power is induced by electromagnetic induction in the power receiving coil 8. The alternating-current power induced in the power receiving coil 8 is transmitted to the contactless power supply IF circuit 9, and rectified into a direct-current power in the contactless power supply IF circuit 9. Then, the direct-current power is supplied to the battery 10. The power supplied to the battery 10 is further supplied to various members for driving the portable television 3. In this way, the portable television 3 can receive power in a contactless manner from the angle 2.

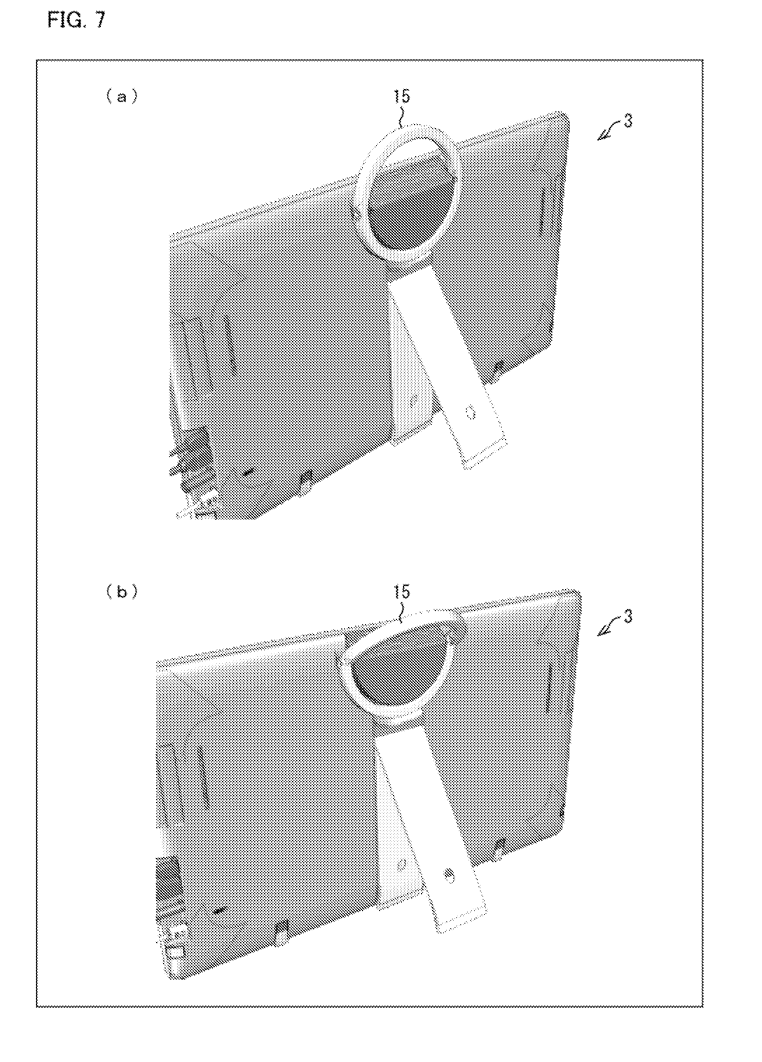

FIG. 6 is a back view and a side view of the portable television 3. Further, FIG. 7 illustrates one example arrangement of the portable television 3. As illustrated in FIG. 6, the portable television 3 has the handle 15 on a back surface (a side opposite to a display surface). The handle 15 is provided for hanging the portable television 3 on the angle 2. Inside the handle 15, the power receiving coil 8 that is bendable and has a ring shape is embedded. More specifically, as indicated by a dotted line in FIG. 6, the power receiving coil 8 is embedded in the handle 15 in accordance with the shape of the handle 15. In this way, the power receiving coil 8 is embedded in the handle 15, and thereby, a space in the handle 15 is effectively utilized. Accordingly, it is not necessary to separately provide a space for provision of the power receiving coil 8 in a space in the portable television 3. This makes it possible to embed the power receiving coil 8 in the thin portable television 3 without any problem.

Further, because the power receiving coil 8 is embedded in the handle 15, a distance can be provided between the power receiving coil 8 and a metal member such as a backlight chassis inside the main body of the portable television 3. This makes it possible to minimize heat generation of the metal member which occurs due to the power receiving coil 8.

Further, by having an arrangement in which only a it becomes possible to design the handle 15 independently from a size and a shape of the main body of the portable television 3 so that the handle 15 has a desired structure. In other words, even in a case where a power receiving coil 8 in accordance with a required transmission power is to be embedded, the handle 15 can be designed in accordance with the power receiving coil 8 to be embedded.

When the portable television 3 is carried around or hung on the angle 2, this handle 15 extends beyond the top edge of the portable television 3, as illustrated in (a) of FIG. 7. In this case, the handle 15 comes in sight of a viewer viewing the portable television 3 when the portable television 3 is placed somewhere and viewed. This may disturb viewing of the viewer. Here, because the power receiving coil 8 is bendable, the handle 15 can be bent as illustrated in (b) of FIG. 7. This removes the handle 15 from the sight of the viewer viewing the portable television 3. Accordingly, the handle 15 does not disturb viewing of the viewer.

Note that the bendable power receiving coil 8 may be, for example, a thin sheet coil. In a case where the power receiving coil 8 is a sheet coil, the handle 15 of the portable television 3 can be easily bent. Further, the power receiving coil 8 made of a sheet coil makes it possible to reduce a thickness and a weight of the power receiving coil 8. Therefore, a size of the handle 15 can be further reduced and a design of the portable television 3 can be enhanced. Note that though a sheet coil is mentioned as the bendable power receiving coil 8, of course, the power receiving coil 8 is not necessarily limited to a sheet coil.

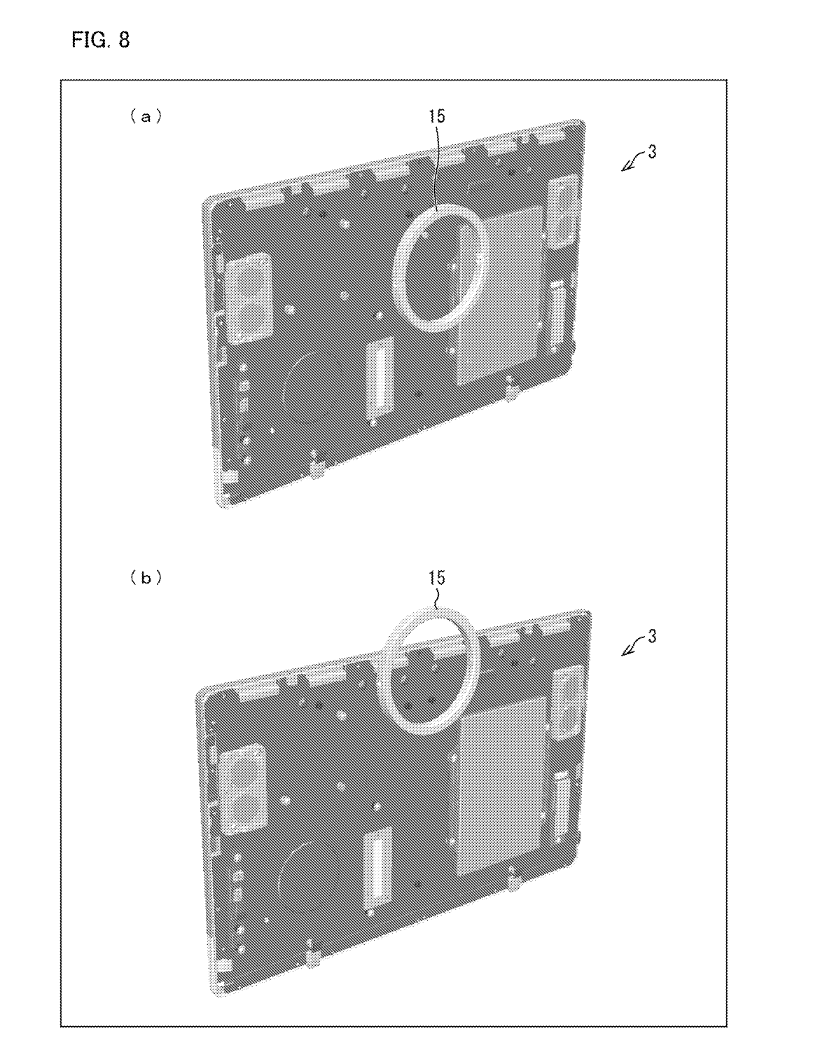

Further, FIG. 8 illustrates a positional relation between the handle 15 and a metal member such as a backlight chassis inside the main body of the portable television 3. In FIG. 8, a back surface of the portable television 3 is omitted so that the positional relation can be clearly illustrated.

(a) of FIG. 8 illustrates a case where the handle 15 is provided in the center of the back surface of the portable television 3. In this case, the entire handle 15 is in contact with the main body of the portable television 3. Accordingly, the metal member such as a backlight chassis inside the main body of the portable television 3 may resonate and generate heat clue to influence of the power receiving coil 8 embedded in the handle 15.

Meanwhile, (b) of FIG. 8 illustrates a case where the handle 15 is provided in a position where a portion of the handle 15 extends beyond the top edge of the portable television 3. In this case, the handle 15 is not entirely in contact with the main body of the portable television 3. Accordingly, as compared to the case of (a) of FIG. 8, the handle 15 is in contact with the main body of the portable television 3 in a smaller area. Therefore, the metal member such as a backlight chassis inside the main body of the portable television 3 resonates and generates heat in a smaller area, due to influence of the power receiving coil 8 embedded in the handle 15. This makes it possible to consequently minimize heat generation of the metal member that occurs due to the power receiving coil 8.

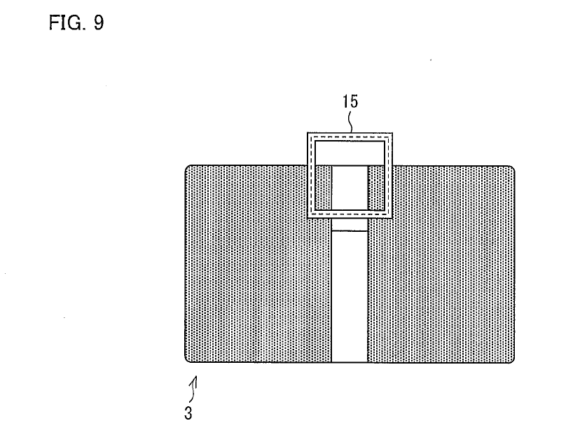

Further, the power receiving coil 8 preferably has a ring shape (circular shape) because power supply efficiency becomes high. However, the shape of the power receiving coil 8 is not necessarily limited to this. As long as the power receiving coil 8 has a loop shape and can be magnetically connected with the power transmitting coil 6, the shape of the power receiving coil 8 may be any shape. For example, FIG. 9 is a back view of a portable television 3 having a power receiving coil 8 that has a rectangular loop shape. As illustrated in FIG. 9, the power receiving coil 8 may have a rectangular loop shape. Alternatively, though not illustrated, the power receiving coil 8 may have a polygonal loop shape, or an elliptical loop shape. Because the power receiving coil 8 is a bendable coil, the power receiving coil 8 may have a various shape.

(Power Supply Method 1 by Use of Contactless Power Supply System 1)

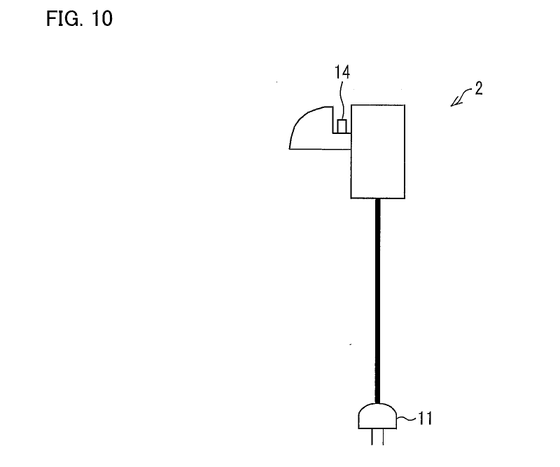

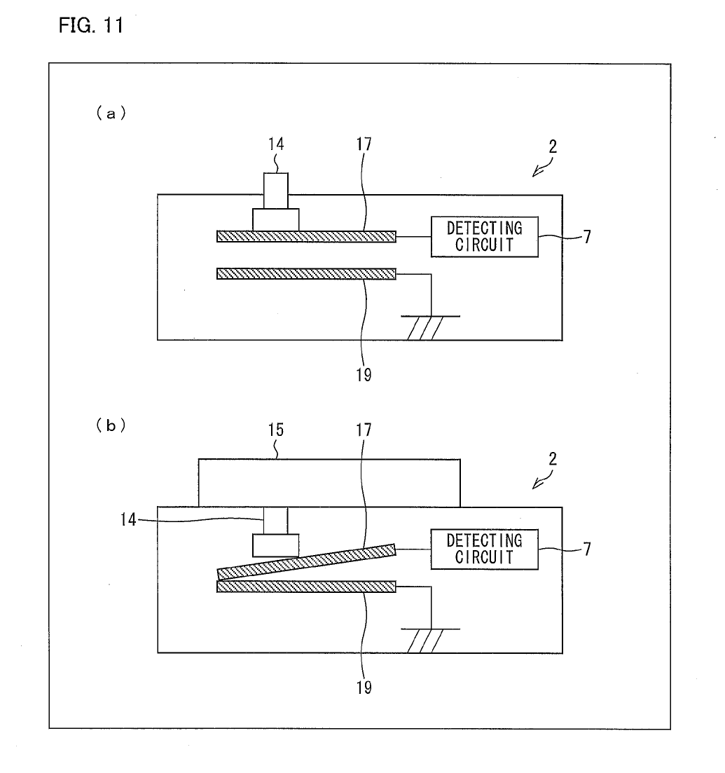

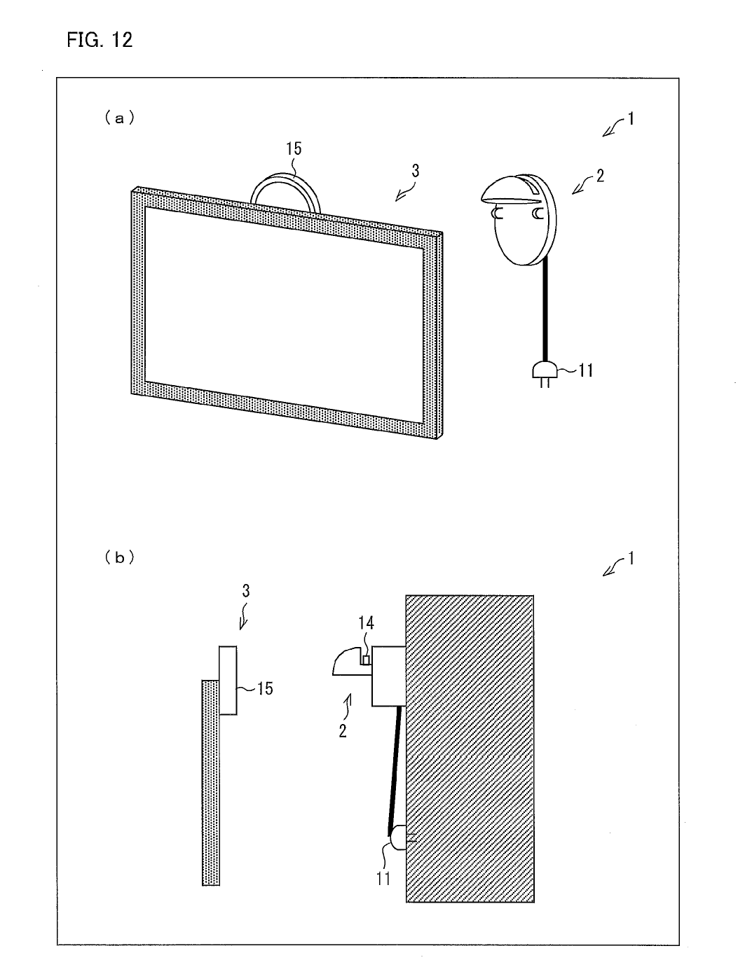

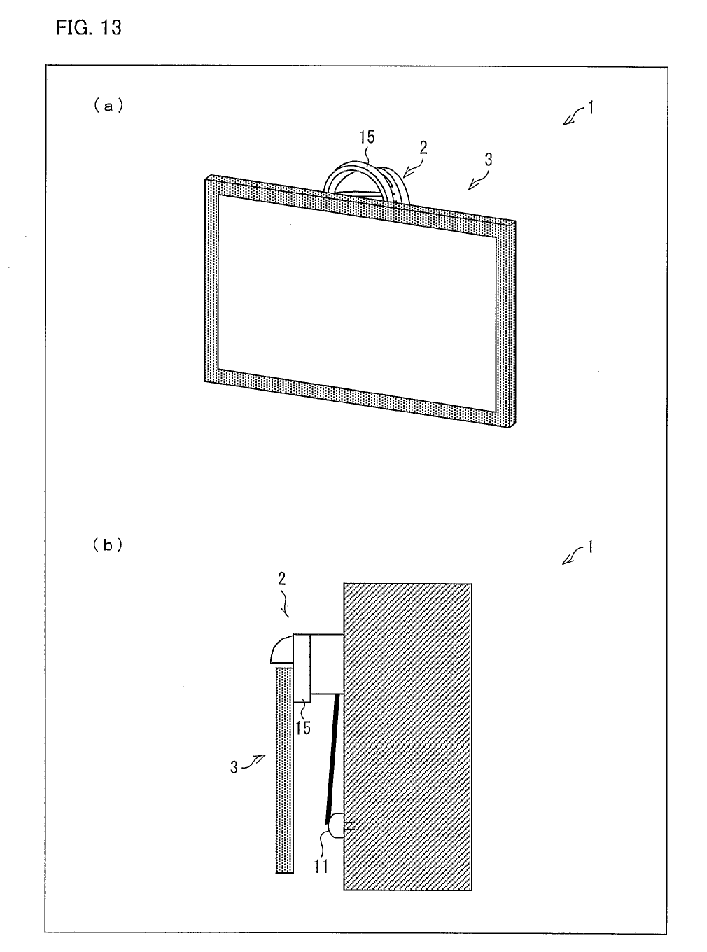

As described above, in the contactless power supply system 1, the angle 2 supplies power to the portable television 3 depending on whether or not the portable television 3 is hung on the angle 2. More specifically, in accordance with a detection result of the detecting circuit 7, the angle 2 supplies power to the portable television 3. Accordingly, the following discusses one example detection method by use of the detecting circuit 7 of the angle 2, with reference to FIGS. 10 and 11. FIG. 10 is a side view illustrating the angle 2. FIG. 11 is a view illustrating an internal arrangement of the angle 2. (a) of FIG. 11 is a view illustrating a state where the portable television 3 is not hung on the angle 2. Meanwhile, (b) of FIG. 11 is a view illustrating a state where the portable television 3 is hung on the angle 2. Note that the following detection method is only one example and the detection method by use of the detecting circuit 7 is not limited to this example.

As illustrated in FIG. 10, the angle 2 is provided with a switch 14 at a position where the handle 15 of the portable television 3 is to be hung. More specifically, as illustrated in (a) of FIG. 11, the angle 2 includes therein a pair of electrodes including a detection electrode 17 and a ground electrode 19 that are provided so as to have a space between these electrodes. The detection electrode 17 is connected to the detecting circuit 7, and in contact with the switch 14. Meanwhile, the ground electrode 19 is grounded. To the detection electrode 17, a minute current is supplied from a power source that is not illustrated.

When the portable television 3 is hung on the angle 2, the handle 15 depresses the switch 14. Accordingly, as illustrated in (b) of FIG. 11, the switch 14 is depressed into the angle 2. As a result, the switch 14 depresses the detection electrode 17 and the detection electrode 17 comes in contact with the ground electrode 19. This electrically connects the detection electrode 17 and the ground electrode 19. Consequently, a current flows between the detection electrode 17 and the ground electrode 19. The detecting circuit 7 detects this current flow and thereby determines that the portable television 3 is hung on the angle 2. On the contrary, in a case where, as illustrated in (a) of FIG. 11, the portable television 3 is not hung on the angle 2, the detection electrode 17 and the ground electrode 19 are not electrically connected and therefore, a current does not flow between these electrodes. Accordingly, the detecting circuit 7 does not detect any current and determines that the portable television 3 is not hung on the angle 2.

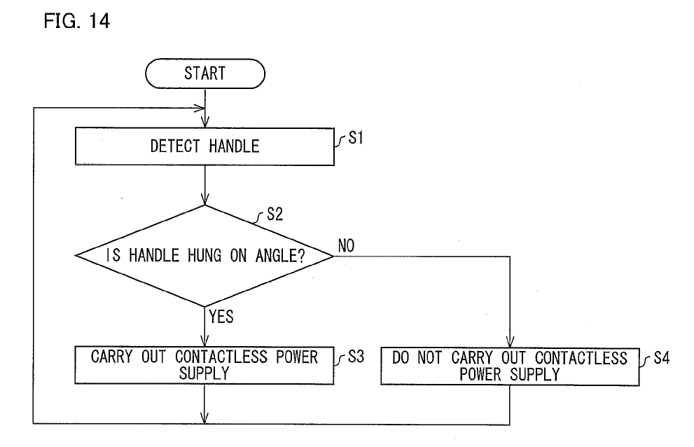

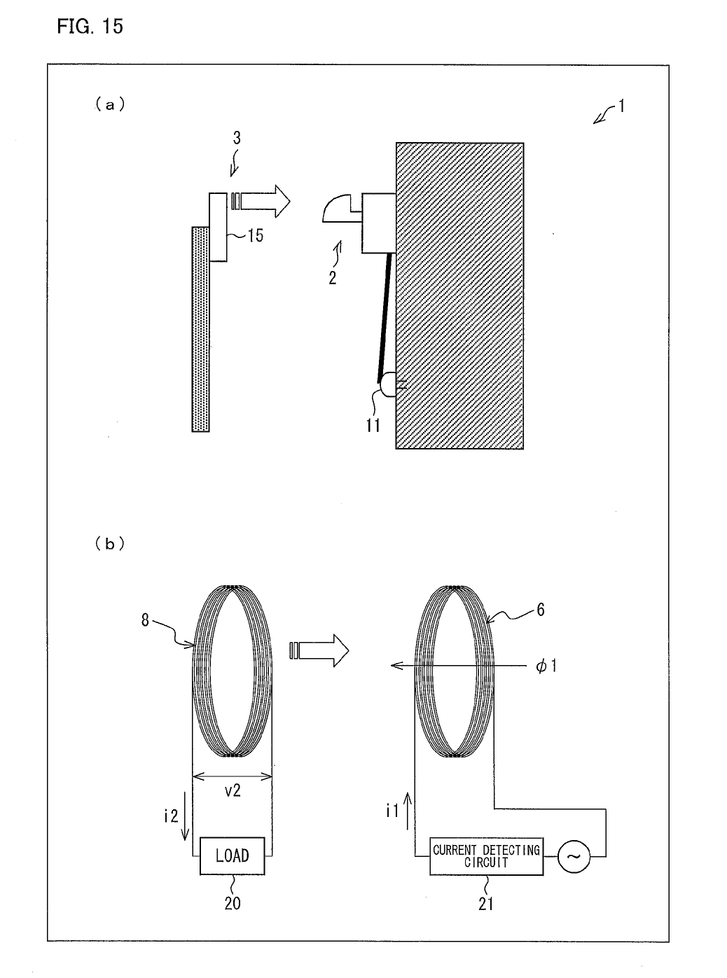

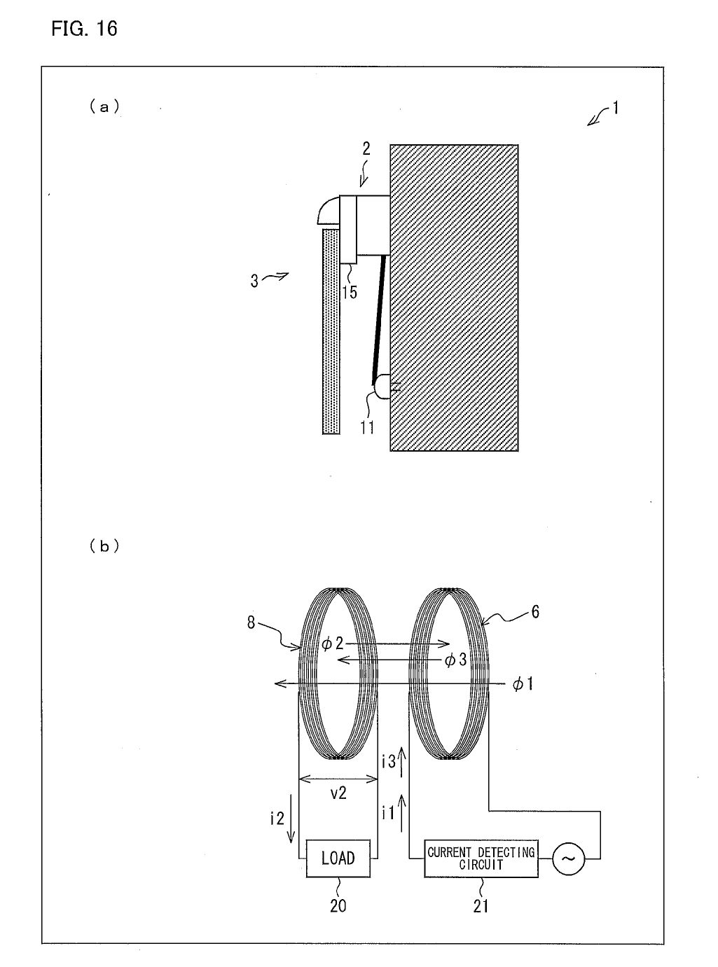

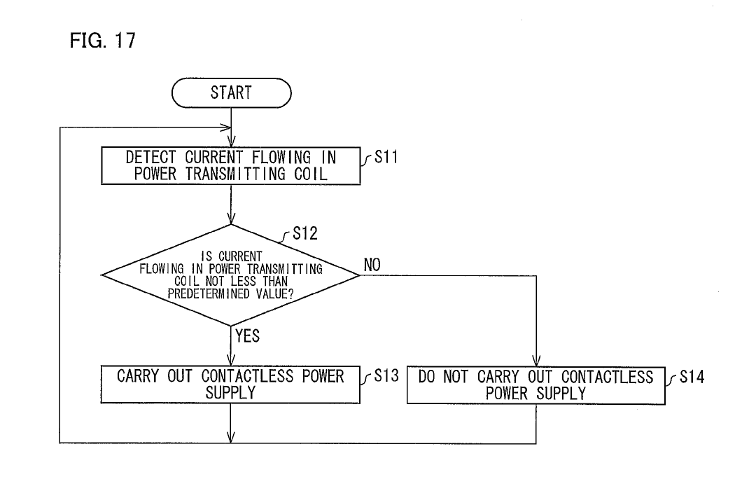

With reference to FIGS. 12 and 13, the following discusses a specific flow from a point at which the detecting circuit 4 detects whether or not the portable television 3 is hung on the angle 2 to a point at which power is supplied to the portable television 3 in accordance with a result of such detection. The flow is discussed, following the steps in FIG. 14. (a) and (b) of FIG. 12 are views each illustrating a state where the portable television 3 is not hung on the angle 2. Meanwhile, (a) and (b) of FIG. 13 are views each illustrating a state where the portable television 3 is hung on the angle 2. Further, FIG. 14 is a flow chart illustrating a power supply method by use of the contactless power supply system 1.

First, the detecting circuit 7 of the angle 2 detects whether or not the portable television 3 is hung on the angle 2. More specifically, the detecting circuit 7 detects whether or not the handle 15 is hung on the angle 2 (Step 1; hereinafter, abbreviated to S1). As illustrated in (a) of FIG. 12, in a case where a viewer is viewing the portable television 3 that the viewer has carried around and put down somewhere, or the like case, the portable television 3 is not hung on the angle 2. Therefore, as illustrated in (b) of FIG. 12, the handle 15 of the portable television 3 does not depress the switch 14 provided to the angle 2, so that no current flows between the detection electrode 17 and the ground electrode 19. As a result, the detecting circuit 7 determines that the portable television 3 is not hung on the angle 2 (No in S2).

Information detected by the detecting circuit 7 is sent to the contactless power supply IF circuit 5. Then, the contactless power supply IF circuit 5 supplies no power to the power transmitting coil 6, in accordance with the information from the detecting circuit 7. In other words, contactless power supply to the portable television 3 is not carried out (S4).

On the other hand, as illustrated in (a) of FIG. 13, in a case where a viewer is viewing or not viewing the portable television 3 that is hung on a wall, or the like case, the portable television 3 is hung on the angle 2. Therefore, as illustrated in (b) of FIG. 13, the handle 15 of the portable television 3 depresses the switch 14 provided to the angle 2. Accordingly, a current flows between the detection electrode 17 and the ground electrode 19. As a result, the detecting circuit 7 determines that the portable television 3 is hung on the angle 2 (YES in S2).

Information detected by the detecting circuit 7 is sent to the contactless power supply IF circuit 5. Then, the contactless power supply IF circuit 5 supplies power to the power transmitting coil 6, in accordance with the information from the detecting circuit 7. In other words, contactless power supply to the portable television 3 is carried out (S3).

Thereafter, the step goes back to S1 and the detecting circuit 7 detects whether or not the handle 15 is hung on the angle 2. Then, processes of S2 and subsequent steps are repeated. By carrying out the above processes repeatedly, in a case where the portable television 3 put down somewhere (a state illustrated in FIG. 12) is hung on the angle 2 (a state illustrated in FIG. 13), the angle 2 starts contactless power supply to the portable television 3. On the other hand, when the portable television 3 hung on the angle (the state illustrated in FIG. 13) is removed from the angle 2 (the state illustrated in FIG. 12), the angle 2 stops contactless power supply to the portable television 3. Therefore, while the detecting circuit 7 detects that the handle 15 is hung on the angle 2, the angle 2 carries out contactless power supply. On the other hand, when the detecting circuit 7 detects that the handle 15 is not hung on the angle 7, the angle 2 stops contactless power supply.

Note that in the above description, even in a case where the detecting circuit 7 determines that the handle 15 is not hung on the angle 2, the detecting circuit 7 sends information on this determination to the contactless power supply IF circuit 5. However, an arrangement of the detecting circuit 7 is not limited to this. The detecting circuit 7 may be arranged to send detection information to the contactless power supply IF circuit 5 only in a case where the detecting circuit 7 detects that the handle 15 is hung on the angle 2. In this case, the contactless power supply IF circuit 5 should supply power to the power transmitting coil 6 only when the detection information is sent from the detecting circuit 7.

(Power Supply Method 2 by Use of Contactless Power Supply System 1)

A method of detecting whether or not the portable television 3 is hung on the angle 2 is not necessarily limited to a detection method using the switch 14. Accordingly, the following discusses one example method of detecting whether or not the portable television 3 is hung on the angle 2 without use of the switch 14, with reference to FIGS. 15, and 16. (a) of FIG. 15 is a view illustrating a state where the portable television 3 is not hung on the angle 2, and (b) of FIG. 15 is a view illustrating a state of the power transmitting coil 6 and the power receiving coil 8 in a case where the portable television 3 is not hung on the angle 2. Meanwhile, (a) of FIG. 16 is a view illustrating a state where the portable television 3 is hung on the angle 2, and (b) of FIG. 16 is a view illustrating a state of the power transmitting coil 6 and the power receiving coil 8 in a case where the portable television 3 is hung on the angle 2.

As illustrated in (a) of FIG. 15, the plug 11 of the angle 2 is connected to an external power source such as a socket outlet, and thereby obtains power from the external power source. More specifically, when the plug 11 of the angle 2 is connected to such an external power source, an exciting current i1 flows into the power transmitting coil, as illustrated in (b) of FIG. 15. Then, through the power transmitting coil, a magnetic flux φ1 is generated. Note that the exciting current i1 at this time can be a minute current and that the exciting current i1 only needs to be capable of exciting a magnetic flux that generates electricity in the power receiving coil 8 in the handle 15 at the time when the portable television 3 is hung on the angle 2. Here, no magnetic flux runs through the power receiving coil 8 in the handle 15. Accordingly, in the power receiving coil 8, a voltage v2 is not generated and no current is flowing (a current i2 is substantially 0 ampere). In this case, a current detecting circuit 21 detects that the current flowing in the power transmitting coil 6 is a current of less than a predetermined value. Then, the current detecting circuit 21 determines that the portable television 3 is not hung on the angle 2. Note that the above predetermined value is a current value that is greater than that of the current i1.

Meanwhile, when the portable television 3 is hung on the angle 2 as illustrated in (a) of FIG. 16, the magnetic flux φ1 excited by the power transmitting coil 6 runs through the power receiving coil 8 in the handle 15 as illustrated in (b) of FIG. 16. Thereby, the voltage v2 is generated in the power receiving coil 8. This voltage v2 causes the current i2 to flow in a load 20 such as an in-television charging circuit connected to the power receiving coil 8. The flow of the current i2 generates a reverse magnetic flux φ2 in the power receiving coil 8. Further, a magnetic flux φ3 is generated in the power transmitting coil 6 in a manner that the magnetic flux φ3 counteracts the magnetic flux φ2. As a result, a current i3 that generates the magnetic flux φ3 is added to the current i1. Consequently, the current flowing in the power transmitting coil 6 increases from the current i1 to a current (i1+i3), due to influence of a load current flowing in the power receiving coil 8. When the current detecting circuit 21 detects that the current flowing in the power transmitting coil 6 increases, that is, the current flowing in the power transmitting coil 6 becomes not less than the predetermined value, the current detecting circuit 21 determines that the portable television 3 is hung on the angle 2.

On the other hand, in a case where the portable television 3 is removed from the angle 2, the reverse magnetic flux φ2 disappears. Accordingly, the magnetic flux φ3 that is generated so as to counteract the magnetic flux φ2 also disappears. As a result, the current i3 also disappears. Therefore, the current flowing in the power transmitting coil 6 decreases by the current i3. When the current detecting circuit 21 detects that the current flowing in the power transmitting coil 6 decreases, that is, the current flowing in the power transmitting coil 6 becomes less than the predetermined value, the current detecting circuit 21 determines that the portable television 3 is not hung on the angle 2.

With reference back to FIGS. 15 and 16, the following discusses a specific flow from a point at which the current detecting circuit 21 detects whether or not the portable television 3 is hung on the angle 2 to a point at which power is supplied to the portable television 3 in accordance with a result of the above detection. The flow is discussed, following the steps in FIG. 17. FIG. 17 is a flow chart illustrating a power supply method by use of the contactless power supply system 1.

First, the current detecting circuit 21 of the angle 2 detects whether or not the portable television 3 is hung on the angle 2. More specifically, the current detecting circuit 21 detects whether or not a current flowing in the power transmitting coil 6 has increased (Step 11; hereinafter, abbreviated to S11). As illustrated in (a) of FIG. 16, in a case where a viewer is viewing or not viewing the portable television 3 that is hung on a wall, or the like case, the portable television 3 is hung on the angle 2. Therefore, as illustrated in (b) of FIG. 16, the current flowing in the power transmitting coil 6 is influenced by the load current flowing in the power receiving coil 8. Accordingly, the current flowing in the power transmitting coil 6 becomes not less than the predetermined value. When the current detecting circuit 21 detects that the current flowing in the power transmitting coil 6 is not less than the predetermined value, the current detecting circuit 21 determines that the portable television 3 is hung on the angle 2 (YES in S12).

Information detected by the current detecting circuit 21 is sent to the contactless power supply IF circuit 5. Then, in accordance with the information from the current detecting circuit 21, the contactless power supply IF circuit 5 increases an amount of power transmitted to the power receiving coil 8 by increasing the current in the power transmitting coil 6. In other words, contactless power supply to the portable television 3 is carried out (S13).

Meanwhile, as illustrated in (a) of FIG. 15, in a case where a viewer is viewing the portable television 3 that the viewer has carries around and put down somewhere, or the like case, the portable television 3 is not hung on the angle 2. Therefore, as illustrated in (b) of FIG. 15, the current flowing in the power transmitting coil 6 is not influenced by the load current flowing in the power receiving coil 8. Accordingly, the current flowing in the power transmitting coil 6 becomes less than the predetermined value. When the current detecting circuit 21 detects that the current flowing in the power transmitting coil 6 is less than the predetermined value, the current detecting circuit 21 determines that the portable television 3 is not hung on the angle 2.

Information detected by the current detecting circuit 21 is sent to the contactless power supply IF circuit 5. Then, in accordance with the information from the current detecting circuit 21, the contactless power supply IF circuit 5 supplies no power to the power receiving coil 8 by causing the current in the power transmitting coil 6 to be a minute current. In other words, contactless power supply to the portable television 3 is not carried out (S14). Thereafter, the step goes back to S11, and the current detecting circuit 21 detects whether or not the handle 15 is hung on the angle 2. Then, processes of S12 and subsequent steps are repeated. By carrying out the above processes repeatedly, in a case where the portable television 3 put down somewhere (a state illustrated in (a) of FIG. 15) is hung on the angle 2 (a state illustrated in (a) of FIG. 16), the angle 2 starts contactless power supply to the portable television 3. On the other hand, when the portable television 3 hung on the angle (the state illustrated in (a) of FIG. 16) is removed from the angle 2 (the state illustrated in (a) of FIG. 15), the angle 2 stops contactless power supply to the portable television 3. Therefore, while the current detecting circuit 21 detects that the handle 15 is hung on the angle 2, the angle 2 carries out contactless power supply. On the other hand, when the current detecting circuit 21 detects that the handle 15 is not hung on the angle 7, the angle 2 stops contactless power supply.

Note that in the above description, even in a case where the current detecting circuit 21 determines that the handle 15 is not hung on the angle 2, the current detecting circuit 21 sends information on this determination to the contactless power supply IF circuit 5. However, an arrangement of the current detecting circuit 21 is not limited to this. The current detecting circuit 21 may be arranged to send detection information to the contactless power supply IF circuit 5 only in a case where the current detecting circuit 21 detects that the handle 15 is hung on the angle 2. In this case, the contactless power supply IF circuit 5 should supply power to the power transmitting coil 6 only when the detection information is sent from the current detecting circuit 21.

Further, as initially discussed, the contactless power supply system 1 according to one embodiment of the present invention carries out contactless power supply from a power supply device to a portable display device that includes a handle. The above has discussed the contactless power supply system 1 according to one embodiment of the present invention, by taking, as an example, a case where the display device is the portable television 3 and the power supply device is the angle 2 for hanging the portable television 3 on a wall. However, this is only one example, and the contactless power supply system 1 according to one embodiment of the present invention is not limited to this arrangement. In addition, a case where contactless power supply is carried out in the contactless power supply system 1 according to one embodiment of the present invention is not limited to a case where the display device (portable television 3) is hung on the power supply device (angle 2).

Therefore, the present invention is not limited to the description of the embodiments above, but may be altered by a skilled person within the scope of the claims. An embodiment based on a proper combination of technical means disclosed in different embodiments is encompassed in the technical scope of the present invention.

### Overview of Embodiments

As described above, in order to solve the above problem, a display device of the present invention is a portable display device having a handle in which a power receiving coil for contactless power supply is embedded.

In the above arrangement, the power receiving coil is embedded in the handle of the display device. In this way, the power receiving coil is embedded in the handle of the display device and thereby, a space in the handle is effectively utilized. Accordingly, it becomes unnecessary to separately provide a space for provision of the power receiving coil, in a space inside the display device. This makes it possible to embed the power receiving coil even in a thin display device without any problem.

Further, by having an arrangement in which only a structure of the handle can be designed as appropriate, it becomes possible to design a handle independently from a size and a shape of a main body of the display device so that the handle has a desired structure. In other words, even in a case where a power receiving coil in accordance with a required transmission power is to be embedded, the handle can be designed in accordance with the power receiving coil to be embedded.

Further, because the power receiving coil is provided in the handle of the display device, it is possible to provide a distance between the power receiving coil and a metal member such as a backlight chassis inside the main body of the display device. This makes it possible to minimize heat generation of the metal member which occurs due to the power receiving coil.

Further, in the portable display device of the present invention, the power receiving coil has a loop shape.

Furthermore, in the portable display device of the present invention, the power receiving coil has a circular loop shape, an elliptical loop shape, or a polygonal loop shape.

The above arrangement makes it possible to obtain high power supply efficiency.

Further, in the portable display device of the present invention, the power receiving coil is a bendable coil.

In the above arrangement, the power receiving coil is a bendable coil. This makes it possible to embed the power receiving coil in the handle of the display device without any problem.

Further, in the portable display device of the present invention, the power receiving coil is a sheet coil.

In the above configuration, the power receiving coil is a sheet coil. Accordingly, the handle can be easily bent. Further, when the power receiving coil is a sheet coil, it is possible to reduce a thickness and a weight of the power receiving coil. This makes it possible to further reduce a size of the handle and consequently, makes it possible to enhance a design of the display device.

Further, in the portable display device of the present invention, the handle is provided in a position where a portion of the handle extends beyond a top edge of the portable display device.

In the above arrangement, the handle of the display device extends beyond the top edge of the display device. Accordingly, in the arrangement, a portion of the handle is in contact with the main body of the display device in a small area. Therefore, a metal member such as a backlight chassis inside the main body of the display device resonates and generates heat in a small area, due to influence of the power receiving coil embedded in the handle. This makes it possible to consequently minimize heat generation of the metal member that occurs due to the power receiving coil.

Further, because a bendable coil is employed as the power receiving coil, the handle can be bent. This removes the handle from the sight of a viewer viewing the display device. Accordingly, the handle does not disturb viewing of the viewer.

In order to solve the above problem, a contactless power supply system of the present invention includes: any one of the above-described portable display devices; and a power supply device including a power source section to which external power is supplied, and a power transmitting coil for contactless power supply, the power transmitting coil being supplied with power from the power source section, in a case where the handle is in a predetermined position in proximity to the power supply device, the contactless power supply being carried out so that the power is supplied to the portable display device by magnetic connection between the power transmitting coil and the power receiving coil.

In the above arrangement, by utilizing electromagnetic induction between the power transmitting coil and the power receiving coil, it is possible to carry out contactless power supply to the display device. Particularly, because the power receiving coil is embedded in the handle of the display device, it is not necessary to separately provide an additional member for the contactless power supply. This makes it possible to carry out contactless power supply to a thin display device without any problem.

Further, the contactless power supply system of the present invention further includes a detecting section for detecting whether or not the handle is in the predetermined position, wherein: in a case where the detecting section detects that the handle is in the predetermined position, the power source section supplies the power to the power transmitting coil; and in a case where the detecting section detects that the handle is not in the predetermined position, the power source section supplies no power to the power transmitting coil.

In the above arrangement, the power supply device carries out contactless power supply while the detecting section is detecting that the handle is in the predetermined position. Meanwhile, the power supply device stops the contactless power supply when the detecting section detects that the handle is not in the predetermined position. Therefore, only while the handle is in the predetermined position, contactless power supply to the display device can be carried out.

Further, the contactless power supply system of the present invention is arranged such that: the power supply device is an angle attached to a wall; the handle is capable of being hung on the angle; and the predetermined position is a position in a state where the handle is hung on the angle.

In the above arrangement, the display device can be hung on a wall. Further, the angle carries out contactless power supply while the detecting section is detecting that the handle is hung on the angle. Meanwhile, the angle stops the contactless power supply when the detecting section detects that the handle is not hung on the angle. Therefore, only while the display device is hung on the angle, contactless power supply to the display device can be carried out.

Further, the contactless power supply system of the present invention is arranged such that: the power supply device is an angle attached to a wall; the handle is capable of being hung on the angle; the predetermined position is a position in a state where the handle is hung on the angle; the angle is provided with a switch; in a case where the handle is depressing the switch provided to the angle, the detecting section detects that the handle is hung on the angle; and in a case where the handle is not depressing the switch provided to the angle, the detecting section detects that the handle is not hung on the angle.

In the above arrangement, the power supply device carries out contactless power supply while the detecting section is detecting that the handle is hung on the angle. Meanwhile, the power supply device stops the contactless power supply when the detecting section detects that the handle is not hung on the angle. Therefore, only while the display device is hung on the angle, contactless power supply to the display device can be carried out.

Further, the contactless power supply system is arranged such that: a minute current flows in the power transmitting coil; the detecting section includes a current detecting circuit for detecting whether or not a value of a current flowing in the power transmitting coil is not less than a predetermined value that is greater than a value of the minute current; in a case where the current detecting circuit detects that the value of the current flowing in the power transmitting coil is not less than the predetermined value, the detecting circuit detects that the handle is in the predetermined position; and in a case where the current detecting circuits detects that the value of the current flowing in the power transmitting coil is less than the predetermined value, the detecting circuit detects that the handle is in the predetermined position.

In the above arrangement, the detecting section is capable of detecting, without use of means such as a switch, whether or not the handle is in the predetermined position.

Further, in order to solve the above problem, a television receiver of the present invention includes any one of the above-described portable display devices.

The above arrangement makes it possible to provide a portable television receiver in which a space for provision of the power receiving coil can be sufficiently ensured and in which heat generation of a metal member due to influence of the power receiving coil does not occur.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A contactless power supply system of the present invention can be applied to a portable television receiver and an angle that is placed for hanging the portable television receiver on a wall.

### REFERENCE SIGNS LIST

1 contactless power supply system
2 angle
3 television receiver (portable television)
4 power source substrate
5 contactless power supply IF circuit
6 power transmitting coil
7 detecting circuit
8 power receiving coil
9 contactless power supply IF circuit
10 battery
11 plug
12 power supply device
13 mobile phone
14 switch
15 handle
16 power transmitting coil
17 detection electrode
18 power receiving coil
19 ground electrode
20 load
21 current detecting circuit

1. A portable display device comprising a handle in which a power receiving coil for contactless power supply is embedded.

2. The portable display device as set forth in claim 1, wherein the power receiving coil has a loop shape.

3. The portable display device as set forth in claim 2, wherein the power receiving coil has a circular loop shape, an elliptical loop shape, or a polygonal loop shape.

4. The portable display device as set forth in claim 1, wherein the power receiving coil is a bendable coil.

5. The portable display device as set forth in claim 4, wherein the power receiving coil is a sheet coil.

6. The portable display device as set forth in claim 1, wherein the handle is provided in a position where a portion of the handle extends beyond a top edge of the portable display device.

7. A contactless power supply system comprising:
the portable display device as set forth in claim 1; and
a power supply device including a power source section to which external power is supplied, and a power transmitting coil for contactless power supply, the power transmitting coil being supplied with power from the power source section,
in a case where the handle is in a predetermined position in proximity to the power supply device, the contactless power supply being carried out so that the power is supplied to the portable display device by magnetic connection between the power transmitting coil and the power receiving coil.

8. The contactless power supply system as set forth in claim 7, further comprising a detecting section for detecting whether or not the handle is in the predetermined position,
in a case where the detecting section detects that the handle is in the predetermined position, the power source section supplying the power to the power transmitting coil,
in a case where the detecting section detects that the handle is not in the predetermined position, the power source section supplying no power to the power transmitting coil.

9. The contactless power supply system as set forth in claim 7, wherein:
the power supply device is an angle attached to a wall;
the handle is capable of being hung on the angle; and
the predetermined position is a position in a state where the handle is hung on the angle.

10. The contactless power supply system as set forth in claim 8, wherein:
the power supply device is an angle attached to a wall;
the handle is capable of being hung on the angle;
the predetermined position is a position in a state where the handle is hung on the angle;
the angle is provided with a switch;
in a case where the handle is depressing the switch provided to the angle, the detecting section detects that the handle is hung on the angle; and
in a case where the handle is not depressing the switch provided to the angle, the detecting section detects that the handle is not hung on the angle.

11. The contactless power supply system as set forth in claim 8, wherein:
a minute current flows in the power transmitting coil;
the detecting section includes a current detecting circuit for detecting whether or not a value of a current flowing in the power transmitting coil is not less than a predetermined value that is greater than a value of the minute current;
in a case where the current detecting circuit detects that the value of the current flowing in the power transmitting coil is not less than the predetermined value, the detecting circuit detects that the handle is in the predetermined position; and
in a case where the current detecting circuits detects that the value of the current flowing in the power transmitting coil is less than the predetermined value, the detecting circuit detects that the handle is not in the predetermined position.

12. A television receiver comprising the portable display device as set forth in claim 1.
